(19) United States
(12) Patent Application Publication
(10) Pub. No.: US 2014/0155218 A1
(43) Pub. Date: Jun. 5, 2014

(54) AXIAL FAN DRIVE AND HUB ASSEMBLY FOR EVAPORATIVE COOLING EQUIPMENT

(71) Applicant: JVS Associates, Inc., Port Washington, NY (US)

(72) Inventor: John Santoro, Port Washington, NY (US)

(21) Appl. No.: 14/098,408

(22) Filed: Dec. 5, 2013

Related U.S. Application Data
(60) Provisional application No. 61/733,501, filed on Dec. 5, 2012.

(51) Int. Cl. F16H 1/28

(52) U.S. Cl. CPC F16H 1/28
USPC 475/331

(57) ABSTRACT

According to at least one exemplary embodiment, an axial fan drive and hub assembly is disclosed. The assembly can include a drive unit having a planetary gear arrangement, and a fan hub coupleable to the drive unit. A sun gear of the gear arrangement can be driven by an input shaft, while either the planet gear carrier or the ring gear may be selected to be the output. The assembly can thus facilitate rotating a fan in the same or the opposite direction of rotation as the input shaft. The drive unit can further be easily interchangeable with other drive units having different gear ratios.

### CROSS-REFERENCE TO RELATED APPLICATIONS

This application claims priority to U.S. Provisional Patent Application No. 61/733,501, filed on Dec. 5, 2012, entitled “Axial Fan Drive and Hub Assemble for Evaporative Cooling Equipment,” by John Santoro, which is hereby incorporated by reference in its entirety.

### FIELD OF THE INVENTION

The present invention is directed to axial fan drive and hub assemblies. Specifically, the present invention is directed to an axial fan drive and hub assemblies for evaporative cooling equipment. More specifically, the present invention is directed to an interchangeable axial fan drive and hub assemblies for evaporative cooling equipment.

### BACKGROUND OF THE INVENTION

Common applications for evaporative cooling equipment such as cooling towers include providing cooled process fluid for heating, ventilation, and air conditioning (“HVAC”), manufacturing, refrigeration and electric power generation. The cooling towers serve to transfer heat from the process fluid into the surrounding environment.

In an open circuit cooling tower, the process fluid that needs to be cooled is delivered to the cooling tower and distributed over a heat transfer medium, also known as fill, typically by a series of nozzles that atomize the water over the fill. The fill facilitates heat transfer by promoting evaporation through commingling the process fluid with dry, outside air. The fill provides a large surface area and provides a required time of contact between the process fluid and the dry, unsaturated airstream supplied by the fan within the cooling tower. As the process fluid droplets pass through the fill, heat is transferred to the atmosphere through the saturated discharge airstream of the cooling tower. A portion of the process fluid is lost through the endothermic process of evaporation, leaving the remaining process fluid at a lower temperature than it was before it entered the cooling tower. The cooled water is collected in a collection basin at the bottom of the cooling tower and then withdrawn therefrom.

Closed circuit cooling towers, also known as fluid coolers, have similar functionality, with the difference being that the process fluid is contained within heat transfer coil(s) and not directly exposed to the surrounding environment. Water stored in the collection basin of the unit is sprayed over the coil(s) to promote heat transfer from the liquid to the make-up water, while at the same time promoting the endothermic process of evaporation. The end result is the process fluid within the coil is cooled through evaporation of spray water on the outside surface of the coil, and to a lesser degree, heat is transferred through the temperature gradient between the spray water/intake air temp and the coil when atmospheric conditions allow. Evaporative condensers are substantially identical to a closed-circuit cooling tower or fluid cooler, except for the process medium. In an evaporative condenser, a refrigerant is used as the process medium, in lieu of process fluids. The evaporative condensers are typically used in the refrigeration industry comprising of cold storage, ice skating rinks, cryogenics and so forth.

Airflow through evaporative cooling equipment is typically facilitated by a fan in combination with an intake air conduit and an exhaust air conduit, which are provided for each heat transfer section, or cell, of the cooling tower. In induced draft equipment, the fan is mounted near the exhaust of the evaporative cooling equipment unit and draws air from the intake through the interior of the cooling unit and across the fill and drift eliminator sections. In forced draft equipment, the fan is mounted near the intake and pushes the air through the interior of the cooling unit, across the fill and drift eliminators and out via the exhaust. Typically, the evaporative cooling equipment systems that use axial fans for these applications are single stage systems. While other manufactures employ a forced draft model that utilizes a two stage axial fan system, the fans are mounted to the same shaft and co rotate.

Such axial fans are typically driven by an input shaft coupled to the hub of the fan. The input shaft is fixedly coupled to the hub, with the result that the speed and direction of rotation of the fan is directly dependent on the speed and direction of rotation of the shaft. Due to manufacturing costs and limited applications, known axial fan hubs lack capabilities for varying rotational speed and direction. Where such functionality is desired, external components are usually provided for changing the rotational speed and direction of the input shaft, thereby resulting in the changing of the rotational speed and direction of the fan hub. Despite the foregoing attempts, a need exists for a cost-effective, integrated solution for changing axial fan speed and direction.

### BRIEF SUMMARY OF THE INVENTION

The present invention provides a cost-effective, integrated solution for changing axial fan speed and direction.

According to at least one exemplary embodiment, an axial fan drive and hub assembly is disclosed. The assembly can include a drive unit having a planetary gear arrangement, and a fan hub coupleable to the drive unit. A sun gear of the gear arrangement can be driven by an input shaft, while either the planet gear carrier or the ring gear may be selected to be the output. The assembly can thus facilitate rotating a fan in the same or the opposite direction of rotation as the input shaft. The drive unit can further be easily interchangeable with other drive units having different gear ratios.

In one aspect, an interchangeable system for varying the rotational speed and rotational direction of an axial fan comprises: a fan hub, the fan hub comprising a recess; a casing, the casing being sized and shaped to be disposed within said recess; and a gearing arrangement enclosed within said casing. The gearing arrangement may comprise a plurality of planet gears, a planet carrier, a sun gear, and a ring gear.

In another aspect, an interchangeable drive unit for varying the rotational speed and rotational direction of an axial fan comprises: a casing, the casing being sized and shaped to be disposed within a fan hub recess; and a gearing arrangement enclosed within said casing, the gearing arrangement comprising a plurality of planet gears, a planet carrier, a sun gear, and a ring gear.

In yet another aspect, an system for varying the rotational speed and rotational direction of an axial fan, the system comprising: a fan hub, the fan hub comprising a plurality of fan blades positioned substantially evenly around said fan hub; and a gearing arrangement enclosed within said fan hub, the gearing arrangement comprising a plurality of planet gears, a planet carrier, a sun gear, and a ring gear.

In certain aspects, the fan hub further comprises a plurality of fan blades positioned substantially evenly around said fan hub.

In certain aspects, the casing hexagonal in shape.

In certain aspects, the gearing arrangement is a cycloibal arrangement, a planetary arrangement, a compound planetary arrangement and/or a ring and pinion arrangement.

In certain aspects, the sun gear includes a sleeve for receiving an input shaft.

In certain aspects, the input shaft passes through the system to drive a second system.

In certain aspects, the sleeve includes a notch configured to receive a corresponding notch on the input shaft, thereby fixing the rotation of sun gear to the input shaft.

In certain aspects, the system further comprises a locking mechanism disposed between said casing and said fan hub for preventing the fan hub from rotating in a predetermined direction.

In certain aspects, the ring gear may be fixedly coupled with the fan hub, such that the direction of rotation of the fan hub is the same as the direction of rotation of the sun gear.

In certain aspects, the planet carrier may be fixedly coupled with the fan hub, such that the direction of rotation of the fan hub is opposite to the direction of rotation of the sun gear.

### BRIEF DESCRIPTION OF THE FIGURES

These and other advantages of the present invention will be readily understood with reference to the following specifications and attached drawings, wherein:

FIG. 1 is a front isometric view of an exemplary embodiment of an axial fan drive and hub assembly.

FIG. 2a is a front view of an exemplary embodiment of an axial fan drive and hub assembly.

FIG. 2b is a rear view of an exemplary embodiment of an axial fan drive and hub assembly.

FIG. 3 is a front view of another exemplary embodiment of an axial fan drive and hub assembly.

FIG. 4 is a rear view of another exemplary embodiment of an axial fan drive and hub assembly.

### DETAILED DESCRIPTION OF THE INVENTION

Embodiments of the present invention will be described hereinbelow with reference to the accompanying drawings. Alternate embodiments may be devised without departing from the spirit or the scope of the invention. In the following description, well-known functions or constructions are not described in detail because they would obscure the invention in unnecessary detail. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention,” “embodiments” or “invention” do not require that all embodiments of the invention include the discussed feature, advantage or mode of operation.

According to at least one exemplary embodiment, axial fan drive and hub assembly systems for evaporative cooling equipment may be disclosed. The fan drive and hub assemblies disclosed herein can provide a compact, integrated arrangement for varying the rotational speed and rotational direction of an axial fan. The fan drive and hub assemblies disclosed herein can further allow for rotating the axial fan in a direction different than the direction of the input shaft, as well as rotating the axial feed at a speed different than the speed of the input shaft. As used herein, the term “input shaft” shall be understood to refer to any device coupled to a fan hub that applies torque to the fan hub so as to initiate and/or maintain rotation of the fan hub.

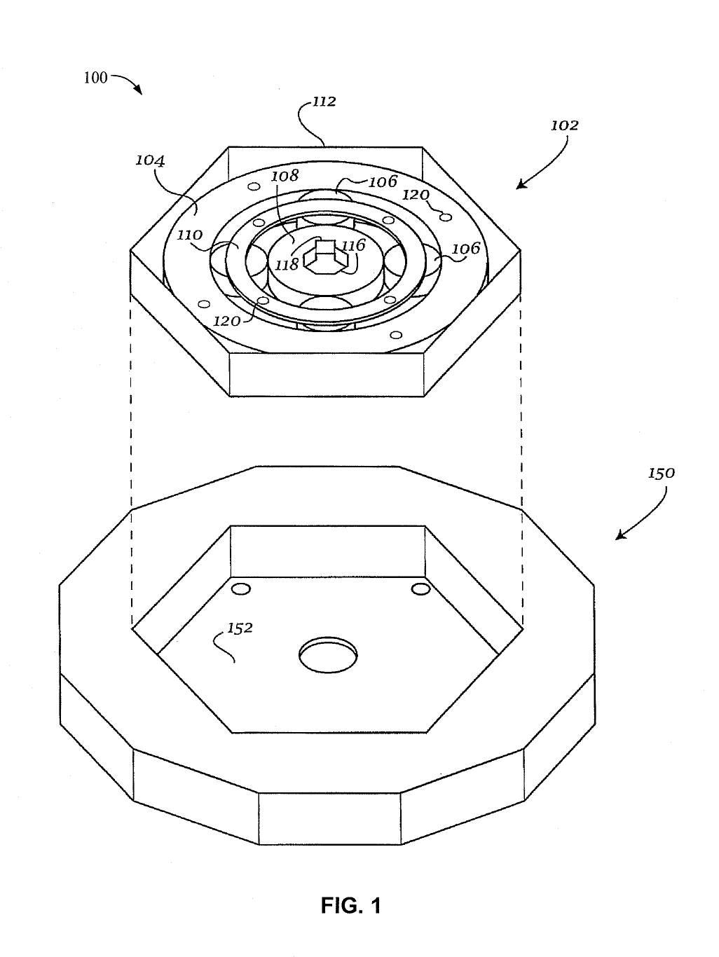

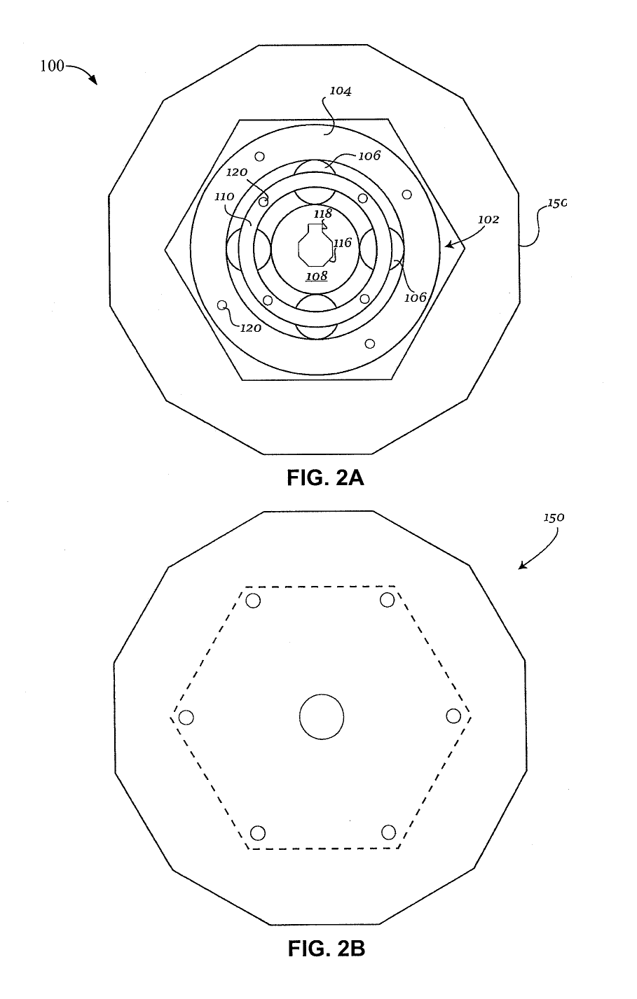

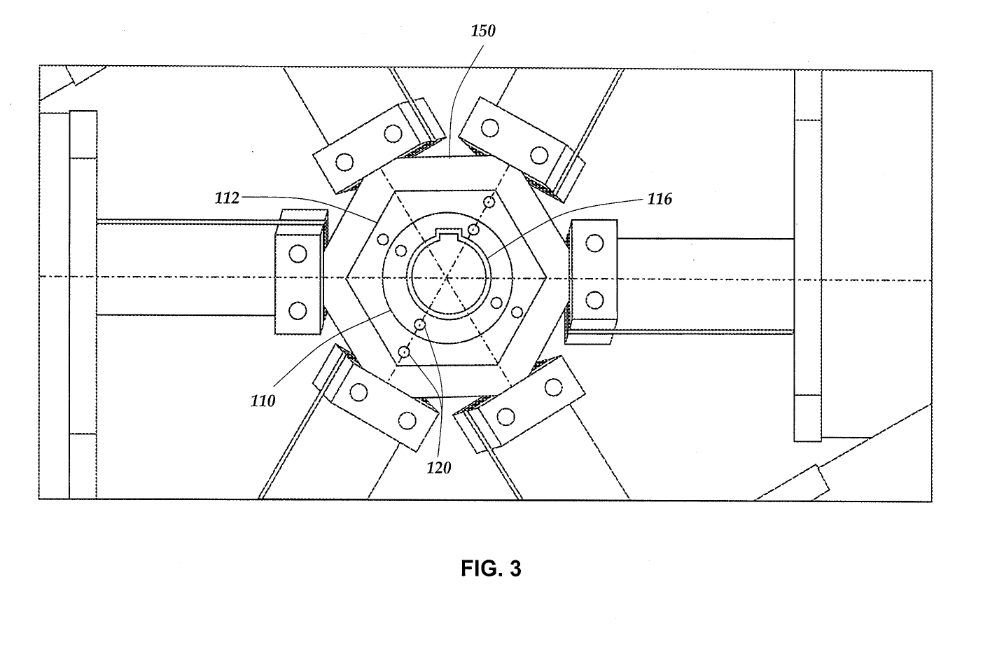

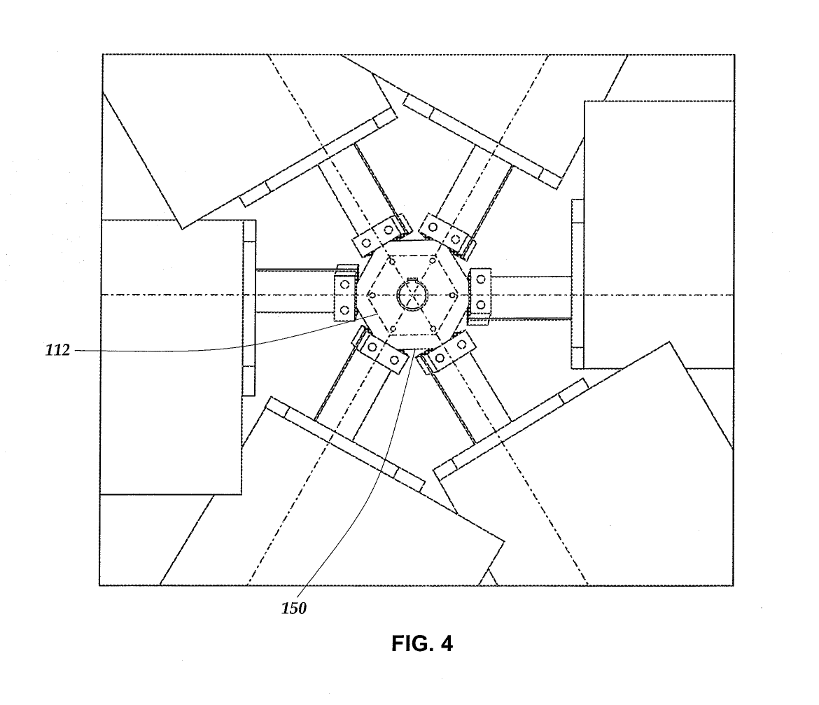

Generally referring to FIGS. 1-4, an exemplary axial fan drive and hub assembly 100 can include a planetary drive unit 102 coupled to a fan hub 150 for an axial fan. The planetary drive unit 102 can include a ring gear 104, a plurality of planet gears 106, and a sun gear 108. Planetary drive unit 102 can have a symmetrical arrangement of planet gears 106, for example four planet gears. Gears 104, 106, 108 can be selected to achieve a desired gear ratio, or a desired ratio of fan speed to input shaft speed that is suitable for the particular application of assembly 100. For example, the symmetrical arrangement of planet gears 106 can allow for easy and straightforward dynamic balancing of the axial fan. The planet gears 106 can further be coupled to a planet carrier 110. The above gears may be fabricated from, for example, steel, alloy steel, stainless steel, cast steel, titanium, aluminum, cast iron, known metal alloys, or a combination thereof.

A casing 112 can enclose, for example, the epicyclic gearing arrangement of planetary drive unit 102. The presently disclosed fan hub streamlines and simplifies the fan system as a whole by eliminating drive components/couplings/transmissions/& mounting brackets that would normally block the pathway of the air from intake to discharge of the fan(s). The casing 112 may be fabricated from, for example, steel, alloy steel, stainless steel, cast steel, titanium, aluminum, cast iron, known metal alloys, or a combination thereof. For example, the power transmission components (i.e., the gearing) may be fabricated from an alloy steel while the transmission case components (e.g., the casing, hub, etc.) may be fabricated from alloy aluminum. The metal may be heat treated to desired strength or hardness design parameters and/or case hardened.

However, one of skill in the art would understand that other materials may be employed to meet a particular need (e.g., corrosion resistance, weight limitations, strength requirements, etc.). For example, the outer surface of the various components may have a weatherproof coating, or similar treatment, and/or made of non-corrosive, or corrosion resistive, alloy such as stainless steel or titanium. Moreover, one of skill in the art would understand that different materials may be used to fabricate the various power transmission components. Similarly, different materials may be used to fabricate the various transmission case components.

While a planetary drive system is generally illustrated, the present invention should not be limited to a planetary drive system for the speed reduction component of the fan hub. Rather, a planetary drive system is merely an example of a possible embodiment. Other suitable drive systems may include, for example, cycloibal arrangement, a compound planetary arrangement (which may contain multiple stages or steps) and/or a ring and pinion arrangement.

A cycloidal arrangement (i.e., a cycloidal drive) may be configured to reduce the speed of an input shaft by a predetermined ratio. An advantage of cycloidal speed reducers is that they are capable of high ratios in relatively compact sizes. In operation, the input shaft drives an eccentric bearing that in turn drives the cycloidal disc in an eccentric, cycloidal motion. The perimeter of this disc is geared to a stationary ring gear and has a series of output shaft pins or rollers placed through the face of the disc. These output shaft pins directly drive the output shaft as the cycloidal disc rotates, however the radial motion of the disc is not translated to the output shaft. In other words, the input shaft may be mounted eccentrically to the ball bearing, causing the cycloidal disc to move in a circle. The cycloidal disc will independently rotate around the bearing as it is pushed against the ring gear. This is somewhere similar to a traditional planetary gear arrangement whereby direction of rotation is opposite to that of the input shaft. The number of pins on the ring gear is larger than the number of pins on the cycloidal disc. This causes the cycloidal disc to rotate around the bearing faster than the input shaft is moving it around, giving an overall rotation in the direction opposing the rotation of the input shaft. The cycloidal disc has holes that are slightly larger than the output roller pins that go inside them. The output pins will move around in the holes to achieve steady rotation of the output shaft from the wobbling movement of the cycloidal disc.

A compound planetary, on the other hand, generally refers to a planetary gear arrangement involving one or more of the following three types of structures: (1) meshed-planet (there are at least two more planets in mesh with each other in each planet train), (2) stepped-planet (there exists a shaft connection between two planets in each planet train), and (3) multi-stage structures (the system contains two or more planet sets). Some designs use a “stepped-planet” that has two differently-sized gears on either end of a common casting. The large end engages the sun, while the small end engages the outer ring gear. This may be necessary to achieve smaller step changes in gear ratio when the overall package size is limited. Compound planets often have “timing marks” (or “relative gear mesh phase”). An advantage of compound planetary gears is that they can easily achieve larger transmission ratio with equal or smaller volume. For example, compound planets with teeth in a 2:1 ratio with a 50 tooth outer ring gear would give the same effect as a 100 tooth outer ring gear, but with half the actual diameter. Indeed, more planet and sun gear units can be placed in series in the same annulus housing (where the output shaft of the first stage becomes the input shaft of the next stage) providing a larger (or smaller) gear ratio.

Finally, a ring and pinion arrangement refers to a bevel gear that permits rotation of two shafts at different speeds. Ring and pinion arrangements are often used on the rear axle of automobiles to allow wheels to rotate at different speeds on curves, but a similar arrangement may be employed with the presently disclosed fan drive and hub assembly.

Casing 112, or a portion thereof, can be removably coupled to fan hub 150 in any desired manner to facilitate interchangeability of the casing 112 and/or the drive unit 102. For example, casing 112 can couple to fan hub 150 by a plurality of fasteners, which may be any desired fastener, for example threaded bolts. Furthermore, the fasteners may be arranged in a symmetrical pattern, for example a hexagonal pattern, so as to allow for ease of dynamic balancing of the axial fan. In some exemplary embodiments, casing 112 may be disposed on a surface of fan hub 150. In other exemplary embodiments, casing 112 may be sized and shaped to be fully or partially disposed within a recess 152 defined in fan hub 150. For example, as illustrated, the casing 112 may be hexagonal in shape and configured to fit within a correspondingly shaped hexagonal recess 152 within the fan hub 150. Employing a hexagonal shaped casing 112 prevents slippage and/or rotation of the casing 112 within the recess 152 defined in fan hub 150 while requiring fewer fasteners. Similarly, strain on the plurality of fasteners used to couple the casing 112 to the fan hub 150 is reduced. While a hexagon is illustrated in the figures, other shapes are contemplated, including, for example, other polygons (e.g., stars, triangular, square, pentagonal, etc.), oval, semicircles, notched, asymmetrical shapes, etc.

Using a casing 112 to removably couple the gearing components (e.g., gears 104, 106, 108, etc.) with the fan hub 150 enabled to operator to “quick change” of the speed reducer for repair, or to change the RPM of the fan hub. Alternatively, the casing 112 and the fan hub 150 may be an integral component. That is, the gearing components of the casing 112 may be directly coupled, or integrated, with the fan hub 150, thereby obviating the need for a casing.

Casing 112 can be adapted so that the planetary drive unit is easily coupleable to and decouplable from fan hub 150. This can allow a user of assembly 100 to quickly and easily change planetary drive unit 102 without having to change fan hub 150, and vice versa. For example, a user may desire to swap drive unit 102 for another drive unit 102 having a different gear ratio, or to swap fan hub 150 for another fan hub 150 having a different amount, or type, of blades, and so forth.

Sun gear 108 can include a sleeve 116 for receiving an input shaft. In some embodiments, sleeve 116 can include a notch 118 that can receive a corresponding notch on the input shaft, so as to fix the rotation of sun gear 108 to the input shaft. In other exemplary embodiments, sun gear 108 may be coupled to the input shaft in any suitable manner. While a sleeve 116 having a notch 118 is illustrated, the sleeve 116 may be sized and shaped to receive a correspondly sized and shaped input shaft. For example, the input shaft and/or sleeve 116 may be a polygon (e.g., stars, triangular, square, pentagonal, hexagon etc.), oval, semicircle, asymmetrically shaped, etc.

Each of planet carrier 110 and ring gear 104 can couple to an external mounting support for the fan. To that end, planet carrier 110 and ring gear 104 can include support coupling structures 120, which may be any coupling structure that enables assembly 100 to function as described herein. For example, coupling structures 120 can be threaded bores that can receive a bolt or other threaded fastener.

Similarly, each of planet carrier 110 and ring gear 104 can be coupled to casing 112, to a portion of casing 112 that is coupled to fan hub 150, or directly to fan hub 150. To that end, planet carrier 110 and ring gear 104 can include hub coupling structures (not shown), which may be any coupling structure that enables assembly 100 to function as described herein. For example, coupling structures can be threaded bores that can receive a bolt or other threaded fastener.

In operation, assembly 100 can allow a user to easily select the direction of fan rotation. For example, if a user desires for the fan to rotate in the same direction as the input shaft, the user may couple the external mounting support to ring gear 104, and couple planet carrier 110 to fan hub 150. Consequently, ring gear 104 remains stationary, while the torque input through the input shaft and sun gear 108 is output through planet carrier 110 to fan hub 150. As a result, the direction of rotation of the fan is the same as the direction of rotation of the input shaft. Alternatively, if a user desires for the fan to rotate in a direction opposite to the direction of rotation of the input shaft, the user may couple the external mounting support to planet carrier 110, and couple ring gear 104 to fan hub 150. Consequently, planet carrier 110 remains stationary, while the torque input through the input shaft and sun gear 108 is output through ring gear 104 to fan hub 150. As a result, the direction of rotation of the fan is the opposite to the direction of rotation of the input shaft.

In some exemplary embodiments, drive unit 102 and fan hub 150 can include apertures for allowing the input shaft to pass through assembly 100. This can facilitate the installation of multiple fans on the same input shaft, as well as the utilization of multiple assemblies 100, thereby allowing for counter-rotating fans to be mounted on a single input shaft, if desired. For example, a single input shaft may be used to drive two or more drive units 102 or a separate system.

The fan hub can be installed into existing installed evaporative equipment quickly and cost effectively in order to convert it to a multi stage fan system. For example, the conversion may be performed by extending the existing fan shaft with a coupling or outright replacement with a longer one. The integrated fan hub may use a stationary support for mounting device. For example a torque arm may be attached to the fan hub base and duct (e.g., fan cowl). The fan hub can be added to existing evaporative cooling equipment in order to modify various performance parameters of the fan system. That is, the drive unit can be easily interchanged with other drive units having different gear ratios.

The presently disclosed fan drive and hub assembly may be employed in cooling towers having horsepower ranges from 1 to 250 horse power (“HP”). For example, the presently disclosed fan drive and hub assembly may be employed in more traditional packaged cooling towers which have motors ranges from 1 to 75 HP. Similarly, they may be similarly employed in field erected cooling towers that range from 76 to 250 HP and up. Generally speaking, the presently disclosed fan drive and hub assembly may be used to drive fans from, for example, 40 inches up to 40 feet in diameter with cubic foot per minute (CFM) typically in excess of 10,000 CFM.

Indeed, the fan hub may be used in conjunction with fan drive system, such as those described in commonly owned PCT application number PCT/US2013/070430, which was filed on Nov. 15, 2013, and parent U.S. patent Ser. No. 13/678,095, filed on Nov. 15, 2012, both are which are hereby incorporated by reference in their entirety.

A multi stage fan system allows for counter rotation as well as co-rotation. Indeed, multi stage fan system may deliver and reap the benefits of co & counter rotating multi stage fan systems including but not limited to altering static pressure, flow rate, HP consumption, fan system efficiency, sound, harmonics, thermal efficiency of evaporative cooling unit, thermal performance of evaporative cooling unit, layout & sound quality of evaporative cooling unit, etc.

In some exemplary embodiments, assembly 100 can include a locking mechanism, so as to allow the fan to spin in one direction while impeding the fan from spinning in the reverse direction. The locking mechanism may be disposed between drive unit 102 and fan hub 150. This can facilitate reducing the likelihood of a “windmilling” effect, wherein fans spin in an opposite direction without being driven, as a result of pressure differentials between the input and output sides of the fan.

In some exemplary embodiments, drive unit 102 may be a sealed, internally lubricated unit. In some embodiments, drive unit 102 may be lubricated with a biodegradable, food grade grease. Furthermore, assembly 100 may be formed from recyclable and/or biodegradable materials. This can reduce the necessity for frequent maintenance of assembly 100 as well as reduce the environmental impact of assembly 100.

The foregoing description and accompanying figures illustrate the principles, preferred embodiments and modes of operation of the invention. However, the invention should not be construed as being limited to the particular embodiments discussed above.

Additional variations of the embodiments discussed above will be appreciated by those skilled in the art. Therefore, the above-described embodiments should be regarded as illustrative rather than restrictive. Accordingly, it should be appreciated that variations to those embodiments can be made by those skilled in the art without departing from the scope of the invention as defined by the following claims.

All documents cited herein, including journal articles or abstracts, published or corresponding U.S. or foreign patent applications, issued or foreign patents or any other documents, are each entirely incorporated by reference herein, including all data, tables, figures and text presented in the cited documents.

What is claimed is:

1. An interchangeable system for varying the rotational speed and rotational direction of an axial fan, the interchangeable system comprising:
a fan hub, the fan hub comprising a recess;
a casing, the casing being sized and shaped to be interchangeably disposed within said recess; and
a gearing arrangement enclosed within said casing.

2. The interchangeable system of claim 1, wherein the gearing arrangement comprises a plurality of planet gears, a planet carrier, a sun gear, and a ring gear.

3. The interchangeable system of claim 1, wherein the fan hub further comprises a plurality of fan blades positioned substantially evenly around said fan hub.

4. The interchangeable system of claim 1, wherein the casing hexagonal in shape.

5. The interchangeable system of claim 2, wherein the sun gear includes a sleeve for receiving an input shaft.

6. The interchangeable system of claim 5, wherein the input shaft passes through the interchangeable system to drive a second system.

7. The interchangeable system of claim 5, wherein the sleeve includes a notch configured to receive a corresponding notch on the input shaft, thereby fixing the rotation of sun gear to the input shaft.

8. The interchangeable system of claim 1, further comprising a locking mechanism disposed between said casing and said fan hub for preventing the fan hub from rotating in a predetermined direction.

9. The interchangeable system of claim 2, wherein the ring gear is fixedly coupled with the fan hub, such that the direction of rotation of the fan hub is the same as the direction of rotation of the sun gear.

10. The interchangeable system of claim 2, wherein the planet carrier is fixedly coupled with the fan hub, such that the direction of rotation of the fan hub is opposite to the direction of rotation of the sun gear.

11. An interchangeable drive unit for varying the rotational speed and rotational direction of an axial fan, the drive unit comprising:
a casing, the casing being sized and shaped to be disposed within a fan hub recess; and
a gearing arrangement enclosed within said casing, the gearing arrangement comprising a plurality of planet gears, a planet carrier, a sun gear, and a ring gear.

12. The interchangeable drive unit of claim 11, wherein the casing hexagonal in shape.

13. The interchangeable drive unit of claim 11, wherein the sun gear includes a sleeve for receiving an input shaft.

14. The interchangeable drive unit of claim 13, wherein the input shaft passes through the interchangeable drive unit to drive a second interchangeable drive unit.

15. The interchangeable drive unit of claim 13, wherein the sleeve includes a notch configured to receive a corresponding notch on the input shaft, thereby fixing the rotation of sun gear to the input shaft.

16. The interchangeable drive unit of claim 11, wherein the ring gear is fixedly coupled with a fan hub, such that the direction of rotation of the fan hub is the same as the direction of rotation of the sun gear.

17. The interchangeable drive unit of claim 11, wherein the planet carrier is fixedly coupled with a fan hub, such that the direction of rotation of the fan hub is opposite to the direction of rotation of the sun gear.

18. A system for varying the rotational speed and rotational direction of an axial fan, the system comprising:
a fan hub, the fan hub comprising a plurality of fan blades positioned substantially evenly around said fan hub; and
a gearing arrangement enclosed within said fan hub, the gearing arrangement comprising a plurality of planet gears, a planet carrier, a sun gear, and a ring gear.

19. The system of claim 18, wherein the sun gear includes a sleeve for receiving an input shaft, wherein the sleeve includes a notch configured to receive a corresponding notch on the input shaft, thereby fixing the rotation of sun gear to the input shaft.

20. The system of claim 18, wherein the ring gear is fixedly coupled with a fan hub, such that the direction of rotation of the fan hub is the same as the direction of rotation of the sun gear.

21. The system of claim 18, wherein the planet carrier is fixedly coupled with a fan hub, such that the direction of rotation of the fan hub is opposite to the direction of rotation of the sun gear.
